(19) United States
(12) Patent Application Publication
(10) Pub. No.: US 2023/0330795 A1
(43) Pub. Date: Oct. 19, 2023

(54) PLATE WITH AT LEAST ONE SLOT IN ITS SURFACE, METHOD FOR PRODUCING A SLOT IN THE SURFACE OF A PLATE, AND SLIDING BLOCK

(71) Applicant: Bernd Siegmund GmbH, 86507 Oberottmarshausen (DE)

(72) Inventor: MICHAEL KAPPEL, Deggingen (DE)

(73) Assignee: Bernd Siegmund GmbH, 86507 Oberottmarshausen (DE)

(21) Appl. No.: 18/028,978

(22) PCT Filed: Sep. 15, 2021
(86) PCT No.: PCT/EP2021/025346

§ 371 Date: Mar. 28, 2023

(30) Foreign Application Priority Data
Sep. 29, 2020 (DE) 10 2020 005 960.0

(51) Int. Cl. B23Q 3/02

(52) U.S. Cl. CPC B23Q 3/02

(57) ABSTRACT

A plate includes a surface having a slot designed for acceptance of a sliding block. The slot has a cross-section which in perpendicular relation to a longitudinal direction of the slot is a hexagon.

The invention relates to a plate with at least one slot in its surface, with the slot being provided for receiving a sliding block, to a method for the production of a slot in the surface of a plate, and to a sliding block which is intended for acceptance in a slot in a surface of a plate.

Plates with at least one slot in their surface are known from the prior art, with the slot being provided for receiving a sliding block. The slot is designed hereby in a T-shape. For this purpose, correspondingly designed T-shaped sliding blocks are known, which can be accommodated in the slot. Clamping elements or the like can usually be fastened to the sliding blocks, typically in threaded bores.

Plates of this type find application in particular in slot tables, in which a plurality of slots are arranged parallel to one another, wherein the slots can extend in transverse direction, in longitudinal direction, or both in transverse and longitudinal directions of the plate. Furthermore, it is known to additionally provide these slot tables with bores, which are arranged in a regular grid, provided in the surface of the slot table and optionally in existing sidewalls, and form part of welding and clamping table systems. Welding and clamping table systems are based on a flexible modular system comprised of a combination of system bores and compatible clamping elements. The clamping elements include stops, angles, bolts, clamps, prisms, supports and other accessories.

Known plates with T-shaped slot have the drawback that the T-slots are complex to make and require a great material thickness of the plate.

The invention is therefore based on the problem to provide a plate with at least one slot in its surface, a method for the production of a slot in the surface of a plate, and a sliding block, wherein the slot can be produced in a simple and inexpensive manner.

This problem is solved with the features of the independent claims. Advantageous configurations of the invention are set forth in the dependent claims.

A plate according to the invention with at least one slot in its surface, with the slot being provided for acceptance of a sliding block, is proposed to have for the slot a cross-section which in perpendicular relation to the longitudinal direction of the slot is a hexagon. Compared to known T-slots, a hexagonal slot can be produced more simply and more cost-effectively, in particular due to lower tool costs. The slot according to the invention can be accommodated in a lesser material thickness, thereby reducing the weight of the plate. Still, compared to known T-slots, greater diameters of the threaded bores of the sliding blocks can be realized.

In the case of the slot according to the invention with a hexagonal cross-section in perpendicular relation to the longitudinal direction of the slot, the depth and width of the slot are dependent on the angle that the surfaces of the slot abutting on the surface of the plate enclose with the surface of the plate. It has proven to be advantageous hereby for the surfaces of the slot that abut on the surface of the plate to enclose with the surface of the plate an angle in the range of 42° to 48°, preferably 45°. An angle of 45° is considered an optimal manufacturing range for the tools and machines in terms of production technology.

A configuration of the invention provides for the arrangement of several slots in parallel relation to one another, with the slots extending in transverse direction, in longitudinal direction or both in transverse and longitudinal directions of the plate. Such a plate can be used, for example, in conjunction with table legs as a slot table. The result is a flexible clamping and guiding system for fast and stable fastening of parts in almost any position and orientation, in particular for shifting and positioning accessories and structures or different movable system elements that can be guided, positioned and tightened via one, two or more slots.

To produce the slot according to the invention in the surface of a plate, it is proposed that the plate be machined with a disc milling cutter from the left and from the right at an angle in the range of 42° to 48°, preferably 45° in relation to the surface of the plate and then the resultant slot is broached with a face cutter at a right angle to the surface of the plate. In addition, provision can be made for the edges of the slot on the surface of the plate to be machined with a radius cutter.

In the case of the sliding block according to the invention, which is intended for acceptance in a slot in a surface of a plate, it is proposed that the sliding block has a cross-section in perpendicular relation to the longitudinal direction of the slot, which cross-section is a hexagon. Such a sliding block can be produced easily and inexpensively and advantageously interacts with the slot with hexagonal cross-section in perpendicular relation to the longitudinal direction of the slot in the plate. The sliding block can be placed into the slot from one side of the plate.

In particular in the case of a plate with a several slots arranged parallel to one another, with the slots extending both in transverse and in longitudinal directions of the plate, it is advantageous when the length of the sliding block is greater than the maximum width of the cross-section of the slot in perpendicular relation to the longitudinal direction of the slot. This ensures that the sliding block is able to also bridge the gaps at the crossings of the slots and a clamping is possible in these crossing zones.

In order to increase possible applications of the sliding block according to the invention, it is proposed for the sliding block to be designed for threading into the slot from above and for rotation in the slot. This sliding block also allows insertion over the table top directly into the slot. When being tightened, the sliding block aligns itself, positions itself transversely in the slot, and blocks. This is particularly useful for long slots or when loading the plate does not allow the sliding block to be inserted from the side.

Embodiments of these sliding blocks can be rotated by 90° in the slot or by 41.5°. For this purpose, material is removed point-symmetrically from a sliding block according to the invention with a hexagonal cross-section in perpendicular relation to the longitudinal direction of the slot, in order to enable threading into the slot and rotation in the slot.

Possible applications of a sliding block can be expanded by providing the sliding block with a threaded bore and assigning to the sliding block a cylindrical clamp adapter, which is connectable to the sliding block with a threaded screw and is provided with a cylindrical foot piece to receive a clamping tool. The clamp adapter enables the use of standard clamps from the accessories of a welding and clamping table system.

Exemplary embodiments of the invention are explained in greater detail in the drawing. It is shown in:

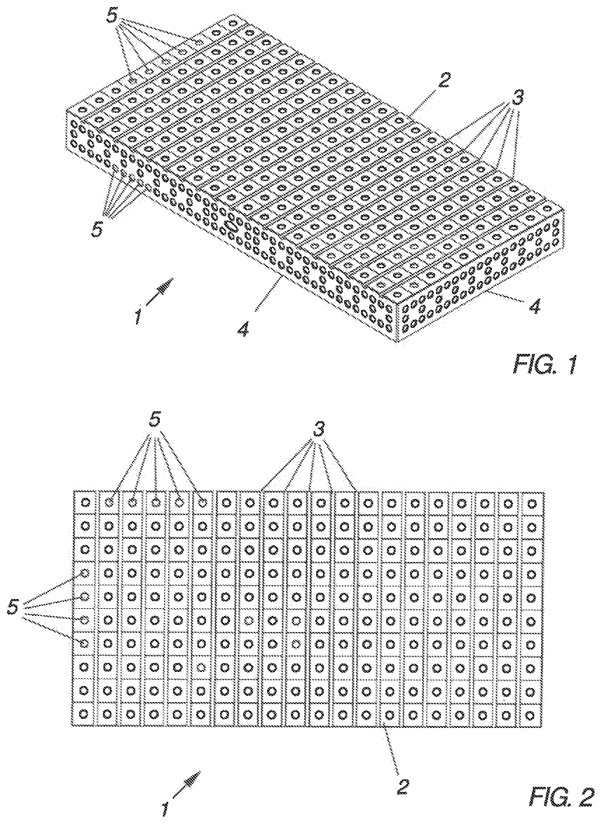

FIGS. 1, 2, 3 various views of a plate including an enlarged slot,

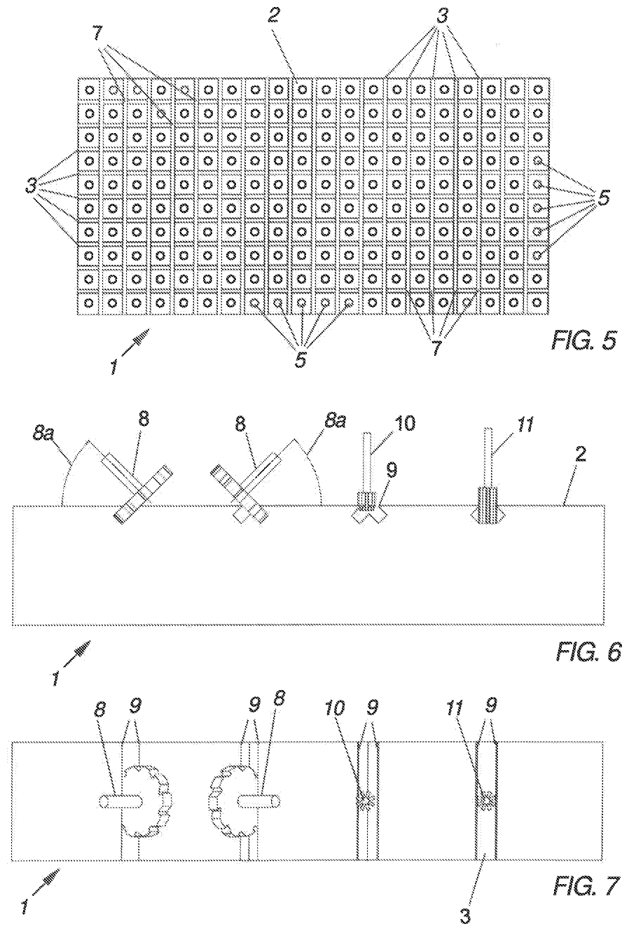

FIGS. 4, 5 top views of other plates,

FIGS. 6, 7 schematic illustrations of the production steps of a slot,

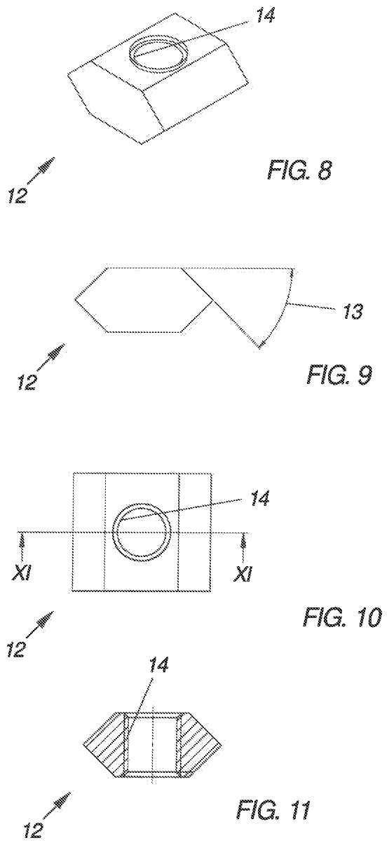

FIGS. 8, 9, 10 various views of a sliding block,

FIG. 11 a section along the line XI-XI of FIG. 10,

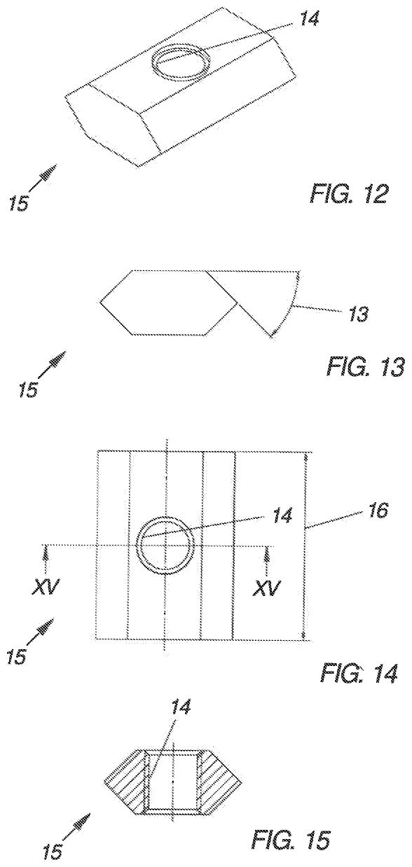

FIGS. 12, 13, 14 various views of another sliding block,

FIG. 15 a section along the line XV-XV of FIG. 14,

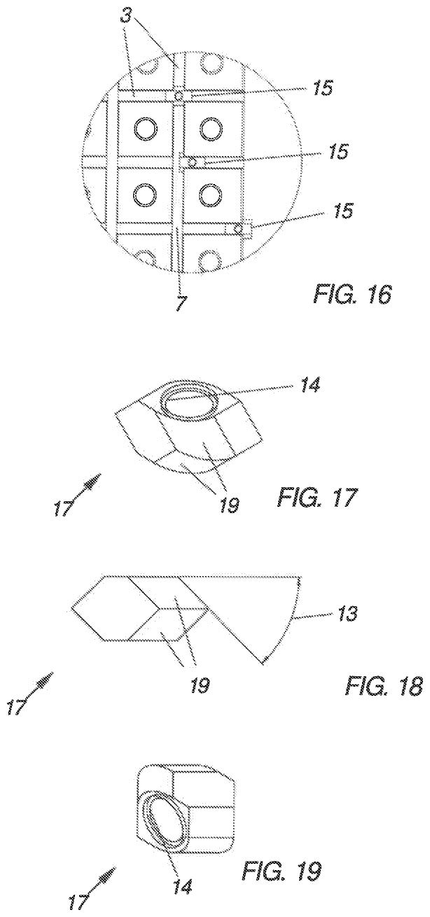

FIG. 16 an enlarged detail of a plate with sliding blocks,

FIGS. 17, 18, 19, 20 various views of another sliding block,

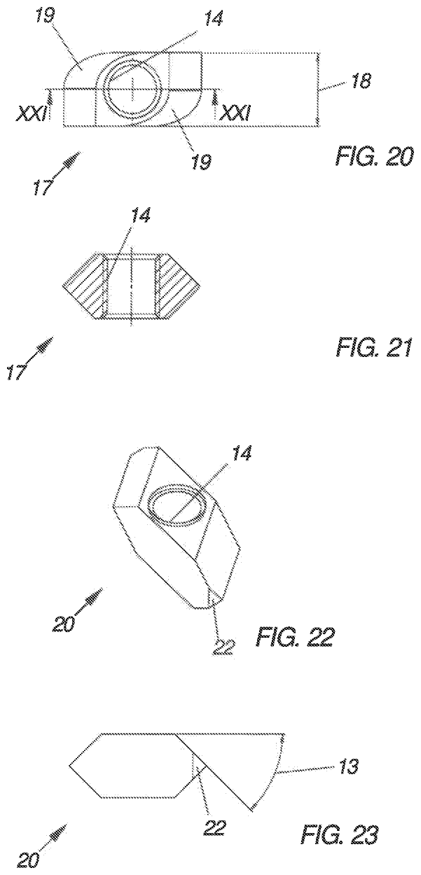

FIG. 21 a section along the line XXI-XXI of FIG. 20,

FIGS. 22, 23, 24 various views of another sliding block,

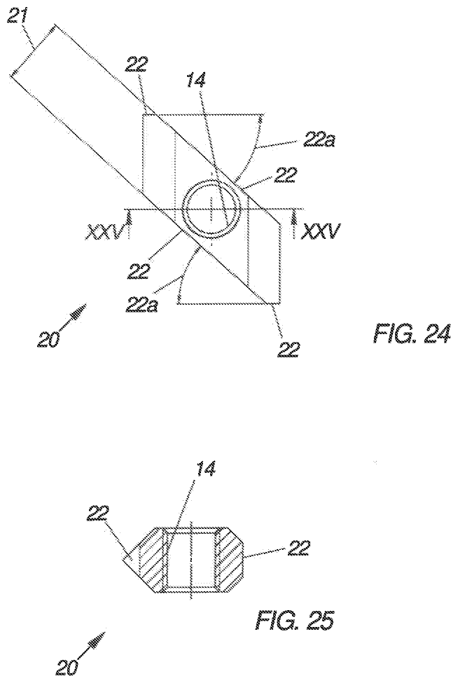

FIG. 25 a section along line XXV-XXV in FIG. 24,

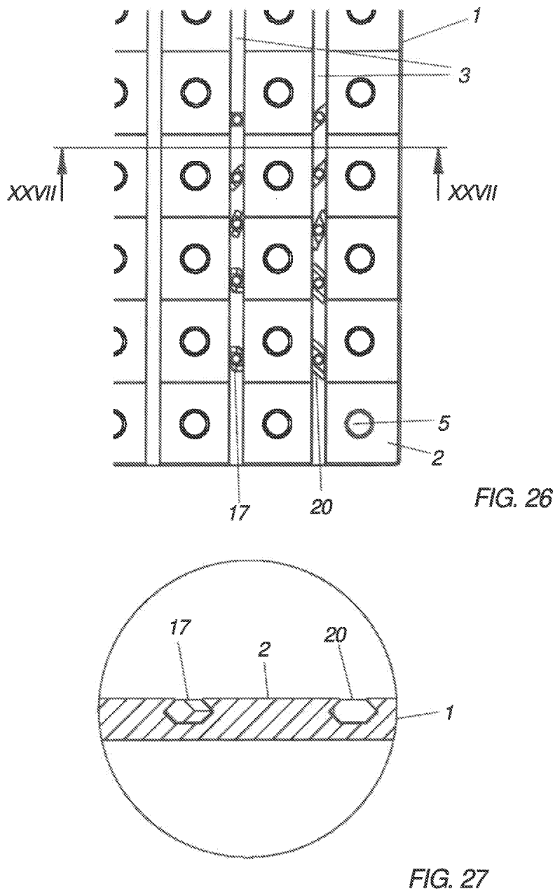

FIG. 26 a detail of a plate with sliding blocks,

FIG. 27 a section along line XXVII-XXVII in FIG. 26,

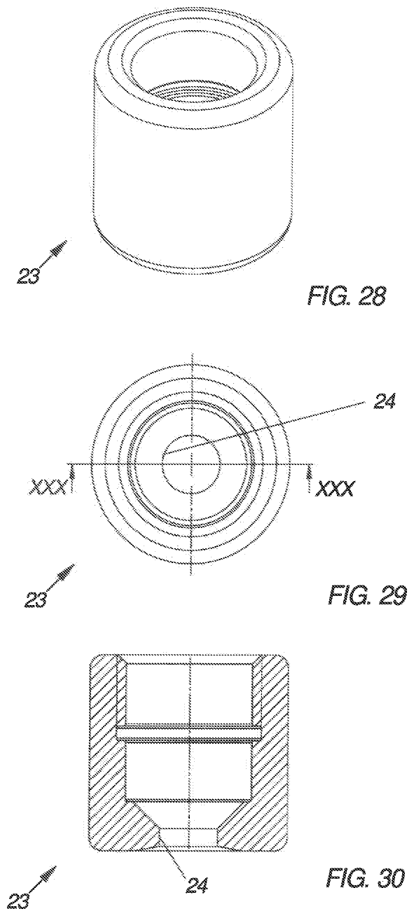

FIGS. 28, 29 various views of a clamp adapter,

FIG. 30 a section along line XXX-XXX of FIG. 29,

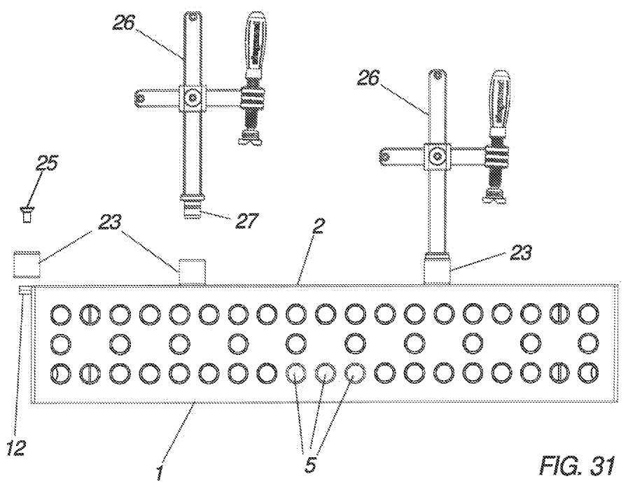

FIG. 31 a plate with sliding block, clamp adapter and clamping tool.

FIGS. 1, 2, 3 show a plate 1 which has a surface 2 with several slots 3 arranged parallel to one another, with the slots 3 extending in transverse direction of the plate 1. The plate 1 is provided with sidewalls 4 and additionally with bores 5, which are arranged in a regular grid in the surface 2 and in the sidewalls 4. It is to be understood that neither the bores 5 nor the sidewalls 4 are necessarily required for the present invention.

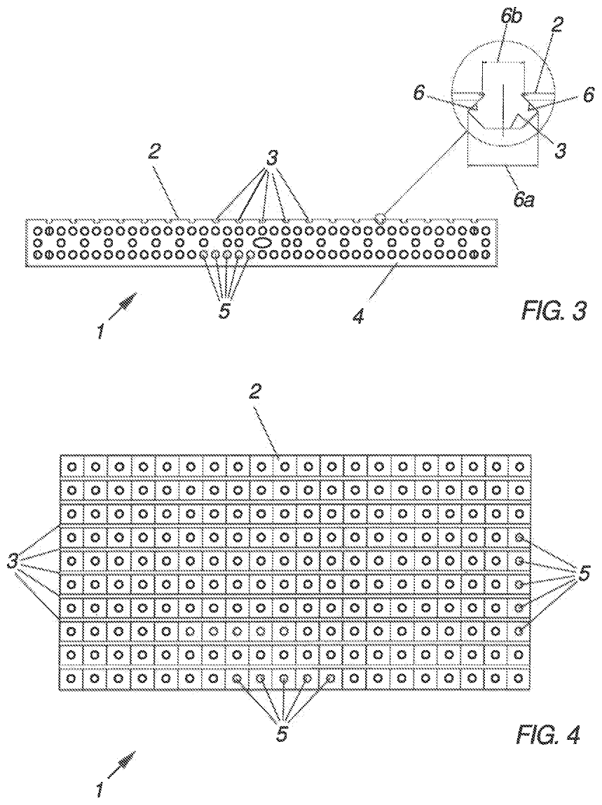

It is readily apparent form the enlarged illustration of a slot 3 in FIG. 3 that the cross-section of the slot 3 in perpendicular relation to the longitudinal direction of the slot 3 is a hexagon. The surfaces 6 of the slot 3 abutting on the surface 2 of the plate 1 enclose an angle of 45° with the surface 2 of the plate 1. According to the invention, an angular range of 42° to 48° has proven hereby to be advantageous. The maximum width of the slot 3 is designated by 6a and the open width of the slot 3 by 6b.

FIGS. 4 and 5 illustrate other plates 1, which differ from the plate of FIGS. 1 to 3 by the pattern of the slots 3. In the plate 1 of FIG. 4, the slots 3 run in longitudinal direction of the plate. In the plate 1 of FIG. 5, the slots 3 run both in transverse and in longitudinal directions of the plate 1, i.e. they form crossing zones 7.

The method for the production of the slots 3 in the surface 2 of the plate 1 is explained in greater detail with reference to FIGS. 6 and 7. Initially, the plate 1 is machined with a disc milling cutter 8 from the left and from the right at an angle 8a of 45°. According to the invention, an angular range of 42° to 48° has proven to be advantageous. It is to be understood that the sequence plays no role here.

Subsequently, the edges 9 of the slot 3 on the surface 2 of the plate 1 are machined with a radius cutter 10. The resultant slot 3 is then broached with a face milling cutter 11 at a right angle to the surface 2 of the plate 1. The sequence of the last two method steps may also be reversed, i.e. the slot 3 is initially broached with the face milling cutter 11 and only at the conclusion are the edges 9 machined with the radius milling cutter 10.

FIGS. 8 to 11 show a sliding block 12 which is intended for acceptance in the slot 3 in the surface 2 of the plate 1. As is particularly apparent from FIGS. 9 and 11, the sliding block 12 has a cross-section in perpendicular relation to the longitudinal direction of the slot 3, which cross-section is a hexagon. The angle 13 is hereby 45°, with an angle range of 42° to 48° proven to be advantageous according to the invention. The sliding block 12 has a threaded bore 14 in which clamping elements or the like can be attached.

FIGS. 12 to 15 show another sliding block 15 which is also intended for acceptance in the slot 3 in the surface 2 of the plate 1. FIGS. 13 and 15 particularly clearly show that this sliding block 15 also has a cross-section in perpendicular relation to the longitudinal direction of the slot 3, which cross-section is a hexagon. The angle 13 is hereby 45°, with an angle range of 42° to 48° proven to be advantageous according to the invention. The sliding block 15 has a threaded bore 14 in which clamping elements or the like can be attached. In contrast to the sliding block 12 of FIG. 8 to 11, the length of the sliding block 15, designated by 16, is greater than the maximum width 6a of the cross-section of the slot 3 in perpendicular relation to the longitudinal direction of the slot 3.

The illustration of FIG. 16 clearly shows that the sliding block 15 can also bridge the gaps at the crossing zones 7 of the slots 3 as a result of its length, and a clamping in these crossing zones 7 is possible.

FIGS. 17 to 21 show another sliding block 17 which, as is readily apparent from FIGS. 18 and 21, has a cross-section in perpendicular relation to the longitudinal direction of the slot 3, which cross-section is a hexagon. The angle 13 is hereby 45°, with an angle range of 42° to 48° proven to be advantageous according to the invention. The sliding block 17 has a threaded bore 14 in which clamping elements or the like can be attached.

The sliding block 17 is designed in such a way that it can be threaded into the slot 3 from above and can be rotated in the slot 3. For this purpose, the width 18 is smaller than the open width 6b of the slot 3. Furthermore, material on the surfaces 19 has been point-symmetrically removed so that the sliding block 17 is rotatable by 90° in the slot 3.

FIGS. 22 to 25 show a further sliding block 20 which, as is particularly apparent from FIGS. 23 and 25, has a cross-section in perpendicular relation to the longitudinal direction of the slot 3, which cross-section is a hexagon. The angle 13 is hereby 45°, with an angle range of 42° to 48° proven to be advantageous according to the invention. The sliding block 20 has a threaded bore 14 in which clamping elements or the like can be attached.

The sliding block 20 is designed in such a way that it can be threaded into the slot 3 from above and is rotatable in the slot 3. For this purpose, the width 21 is smaller than the open width 6b of the slot 3. Furthermore, material has been removed point-symmetrically on the surfaces 22, so that the sliding block 17 in the slot 3 is rotatable by an angle 22a, which is 41.5° in the exemplary embodiment.

Threading and rotating of the sliding blocks 17, 20 are explained in greater detail with reference to the detailed illustrations of FIGS. 26 and 27. In the lowermost illustration of FIG. 26, the sliding blocks 17, 20 are still outside of the slot 3. In the illustration above, the sliding blocks 17, 20 are each placed into the slot 3. The sliding blocks 17, 20 are then rotated clockwise in the slot 3 until reaching the end position of the sliding blocks 17, 20 shown in the uppermost illustration. In particular the enlarged sectional view of FIG. 27 shows the hexagonal cross-section of the sliding blocks 17, 20 in perpendicular relation to the longitudinal direction of the slot 3 in the slot 3.

FIGS. 28 to 30 illustrate a clamp adapter 23 which has a cylindrical shape and is provided with a countersunk bore 24.

As is apparent from FIG. 31, the clamp adapter 23 can be connected to the sliding block 12 with a countersunk screw 25. It is to be understood that the sliding blocks 15, 17 or 20 may also find application here. The clamp adapter 23 is provided for receiving a clamping tool 26 with a cylindrical foot joint 27. The clamp adapter 23 enables the use of standard clamps from the accessories of a welding and clamping table system.

### LIST OF REFERENCE SIGNS

1 plate
2 surface of 1
3 slots
4 sidewalls of 1
bores
6 surface of 3
6a maximum width of 3
6b open width of 3
7 crossing zones
8 disc milling cutter
8a angle
9 edges of 3
10 radius cutter
11 face cutter
12 sliding block
13 angle
14 threaded bore in 12
15 sliding block
16 length of 15
17 sliding block
18 width of 17
19 surfaces of 17
20 sliding block
21 width of 20
22 surfaces of 20
22a angle
23 clamp adapter
24 countersunk bore of 23
25 countersunk screw
26 clamping tool
27 foot joint of 26

What is claimed is:

1.-11. (canceled)

12. A plate, comprising a surface having a slot designed for acceptance of a sliding block, said slot having a cross-section which in perpendicular relation to a longitudinal direction of the slot is a hexagon.

13. The plate of claim 12, wherein the slot has surfaces which abut on the surface of the plate and which enclose with the surface of the plate an angle in a range of 42° to 48°.

14. The plate of claim 12, wherein the slot has surfaces which abut on the surface of the plate and which enclose with the surface of the plate an angle of 45°.

15. The plate of claim 12, further comprising a plurality of said slot arranged parallel to one another, wherein the slots extend in a transverse direction, in the longitudinal direction, or both in the transverse and longitudinal directions of the plate.

16. A method for producing a slot in a surface of a plate, said method comprising:
machining the plate with a disc milling cutter from left and from right at an angle in a range of 42° to 48° in relation to a surface of the plate to make a slot; and
broaching the slot with a face milling cutter at a right angle in relation to the surface of the plate.

17. The method of claim 16, wherein the angle is 45°.

18. The method of claim 16, further comprising machining the edges of the slot on the surface of the plate with a radius cutter.

19. A sliding block for acceptance in a slot in a surface of a plate, said sliding block having a cross-section in perpendicular relation to a longitudinal direction of the slot, which cross-section is a hexagon.

20. The sliding block of claim 19, wherein the sliding block has a length which is greater than a maximum width of a cross-section of the slot in perpendicular relation to the longitudinal direction of the slot.

21. The sliding block of claim 19, wherein the sliding block is designed to be threaded into the slot from above and to be rotatable in the slot.

22. The sliding block of claim 21, wherein the sliding block is rotatable by 90° in the slot.

23. The sliding block of claim 21, wherein the sliding block is rotatable by 41.5° in the slot.

24. The sliding block of claim 19, wherein the sliding block has a threaded bore for connection with a cylindrical clamp adapter via a threaded screw and for receiving a clamping tool with a cylindrical foot piece.
